(19) United States
(12) Patent Application Publication
(10) Pub. No.: US 2026/0258843 A1
(43) Pub. Date: Sep. 3, 2026

(54) SHAFT-HUB ASSEMBLY

(71) Applicant: Stabilus GmbH, Koblenz (DE)

(72) Inventors: Sven Schneider, Neuwied (DE); Wilhelm Schwab, Koblenz (DE)

(21) Appl. No.: 18/879,687

(22) PCT Filed: Jun. 29, 2023
(86) PCT No.: PCT/EP2023/067865

§ 371 Date: Dec. 27, 2024

(30) Foreign Application Priority Data
Jul. 6, 2022 (DE) 102022116887.5

(51) Int. Cl. F16D 1/072; B21J 5/08

(52) U.S. Cl. CPC F16D 1/072; B21J 5/08; F16D 2250/0023

(57) ABSTRACT

The present invention relates to a shaft-hub assembly (30), comprising a hub (10), which is provided with an axially extending opening (12), and a shaft (20), which is inserted into the opening (12) of the hub (10), wherein the shaft (20) comprises at least the following portions: a first axial portion (22a), in which the shaft (20) substantially has a constant cross section (Q1); and a second axial portion (22b), which expands, proceeding from the first axial portion (22a), substantially from a first cross section (Q1) that corresponds to the cross section (Q1) of the first axial portion (22a), to a second, larger cross section (Q2). According to the invention, the shaft (20) further comprises a third axial portion (22c), which adjoins the second axial portion (22b) and which has a substantially constant third cross section (Q3), which is the same as or larger than the second cross section (Q2), and which establishes a form-locking and frictional connection to the hub (10), and the third axial portion (22c) forms an axial end portion of the shaft (20) and the first to third axial portions (22a-22c) have, on the outside thereof, respective toothed or corrugated profiles (24).

The present invention relates to a shaft-hub assembly, comprising a hub, which is provided with an axially extending opening, and a shaft, which is inserted into the opening of the hub, wherein the shaft comprises at least a first axial portion, in which the shaft substantially has a constant cross section and a second axial portion, which expands, proceeding from the first axial portion, substantially from a first cross section that corresponds to the cross section of the first axial portion, to a second, larger cross section. Furthermore, the present invention relates to a method for producing such a shaft-hub assembly.

For shaft-hub assemblies of this type, a play-free connection is required to transmit radial torques and axial forces. However, it is clear that riveted connections known from the prior art usually have the disadvantage that they do not allow for the play-free transmit of torque. In this connection, it is also typically required that the connection between the shaft and the hub must not only withstand static forces, but that its mechanical integrity must be ensured, in particular under dynamic axial and radial loads. If the corresponding connection is not free of play, regardless of whether in the radial or axial direction, the undesirable generation of noise can be observed. However, this is not acceptable for users of such an assembly and must be prevented in any case.

Furthermore, it is known from the prior art to provide a shaft made of a harder material in such assemblies, which shaft has a plurality of radially protruding ribs parallel to the axis. This shaft is pressed into the axially extending opening of the hub, the diameter of which substantially corresponds to the diameter of the shaft without ribs. Since the hub consists of a softer material than the shaft, the ribs will cut into the wall of the hub opening when it is inserted radially. As a result, a play-free torque transmission between the shaft and the hub is intended to be achieved.

However, it has been shown in such configurations of shaft-hub assemblies that the play-free connection between shaft and hub only exists at the ribs, since there is also a play between the cylindrical outer surface of the shaft and the cylindrical wall of the opening of the hub due to manufacturing tolerances.

Furthermore, approaches have been pursued to combine a form-locking connection with an axial securing by means of a riveted connection, as a result of which torques and axial forces can be transmitted to a certain extent. This principle was realized in the prior art by means of a serration and a flat rivet, which are intended to interact in the desired manner. Furthermore, the approach was also taken to achieve a form-locking connection between shaft and hub with the aid of a chamfer.

However, it is clear here that none of the solutions known from the prior art is suitable for transmitting torques and axial forces completely free of play. As already mentioned above, a purely axial riveted connection is not able to transmit torques, while a combination of a form-locking connection with an axial securing by a riveted connection is in principle able to transmit torques and absorb axial forces, but such a connection is not free of play to the required extent. In order to counteract the resulting generation of noise to be observed, an adhesive bond must further be established in such assemblies, which, however, means increased effort in producing it.

The latter approach, with a form-locking connection between shaft and hub with the aid of a chamfer, makes possible a play-free connection without the additional use of adhesives, but the play-free torque that can be transmitted is not sufficient for certain applications with higher load requirements.

It is therefore the object of the present invention to provide a shaft-hub assembly of the above-mentioned type, which comprises a play-free connection for transmitting radial torque and axial force, which on the one hand is inexpensive to produce and does not require additional bonding and on the other hand is capable of transmitting high torques without generating noise.

For this purpose, the shaft of the shaft-hub assembly according to the invention comprises, as mentioned, at least a first axial portion, in which the shaft substantially has a constant cross section, and a second axial portion, which expands, proceeding from the first axial portion, substantially from a first cross section which corresponds to the cross section of the first axial portion, to a second, larger cross section, wherein according to the invention the shaft further comprises a third axial portion, which adjoins the second axial portion and which has a substantially constant third cross section, which is the same as or larger than the second cross section, and wherein the third axial portion forms an axial end portion of the shaft and the first to third axial portions have, on the outside thereof, respective toothed or corrugated profiles.

Accordingly, in the shaft-hub assembly according to the invention, compared to the solutions from the prior art described above, an increase in the contact area of the form-locking connection between shaft and hub is achieved, which allows the transmission of higher moments. In particular, this is achieved by additional radial support of the forces and moments.

In particular, the third axial portion of the shaft can be pressed into the material of the hub. In this way, an additional form-locking and frictional connection is created on the outer walls of the shaft.

For this purpose, in the assembly according to the invention, the shaft can be formed from a harder material than the hub, in order to simplify the pressing of the shaft into the material of the hub. In particular, the shaft can be formed from a metal material and the hub can be formed from a comparatively softer metal material or a plastics material.

Furthermore, according to the invention, a radial step can be provided between the second axial portion and the third axial portion of the shaft, so that the constant third cross section of the third axial portion is larger than the second cross section to which the shaft widens in the second axial portion starting from the first axial portion. As a result, an additional axial support in the region of the step is provided and the connection between shaft and hub is further improved.

Furthermore, in the shaft-hub assembly according to the invention, the second axial portion of the shaft can expand substantially conically from the first axial portion to the third axial portion. Alternatively, however, other courses of the second axial portion are also conceivable, for example an arc-shaped increase in the cross section of the shaft in this region.

Furthermore, the shaft can be provided with a blind hole in a radially central part of the third axial portion, which blind hole starts from the axial end of the shaft.

In addition, the shaft can have an axial stop at the opposite end and can be inserted into the hub up to this stop, as a result of which the connection between the shaft and the hub is improved in this axial direction as well.

According to a second aspect, the present invention relates to a method for producing such a shaft-hub assembly, comprising the steps of providing a hub, which is provided with an axially extending opening, wherein the opening comprises a first axial portion having a substantially constant cross section, a second axial portion that expands, proceeding from the first axial portion, substantially from a first cross section that corresponds to the cross section of the first axial portion to a second, larger cross section, and a third axial portion having a substantially constant cross section, providing a shaft having a substantially constant first cross section that corresponds to the cross section of the first axial portion of the opening, wherein the shaft has, on the outside thereof, a toothed or corrugated profile and the opening of the hub has a complementary profile at least in the first axial portion thereof, and deforming the shaft such that a second portion, which corresponds to the second axial portion of the opening, and a third portion are formed, wherein the third portion of the shaft has a larger cross section than the third axial cross section of the hub, by pressing the third axial portion of the shaft into the material of the hub. By this method, a shaft-hub assembly according to the invention with the advantages mentioned above can be produced in a simple and efficient manner.

According to the invention, before the two components are connected here, only the first axial portion of the opening of the hub can have the complementary profile, while the second axial portion and the third axial portion are free of such a profile.

Furthermore, here the step of deformation can be carried out by an application of axial punching or pressing.

Further features and advantages of the present invention will become more apparent from the following description of an embodiment thereof when considered together with the accompanying figures. In the figures, in detail:

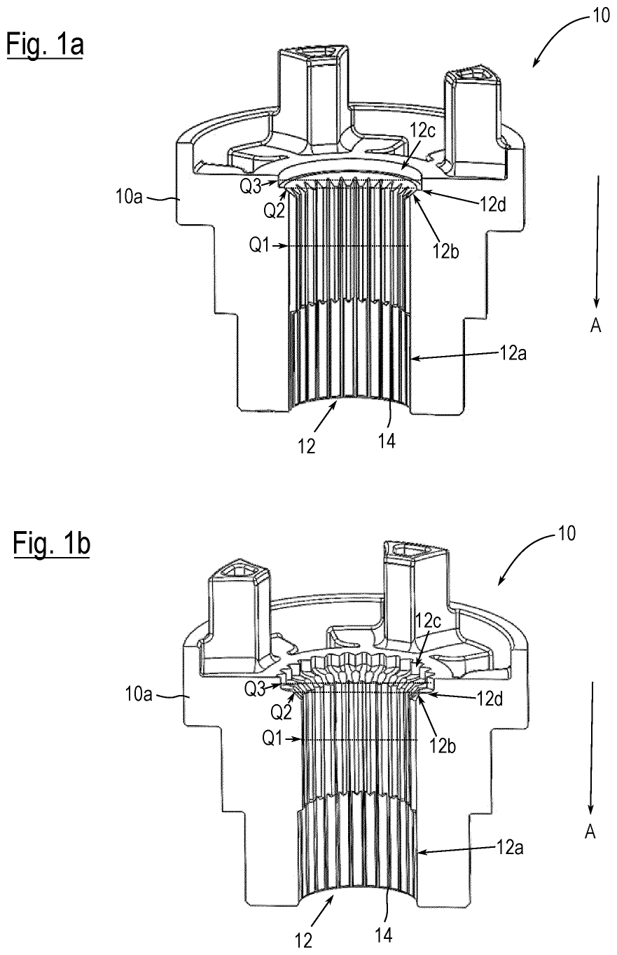

FIGS. 1a and 1b show a hub of a shaft-hub assembly according to the invention before and after connection to the corresponding shaft;

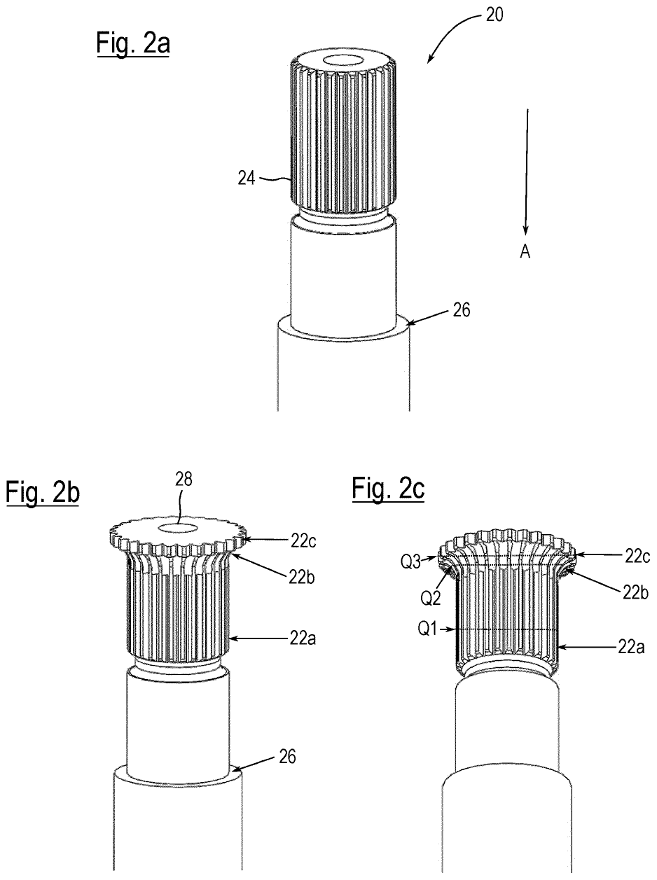

FIGS. 2a to 2c show the shaft of the shaft-hub assembly according to the invention before connection to the hub and after connection to the hub in two views; and

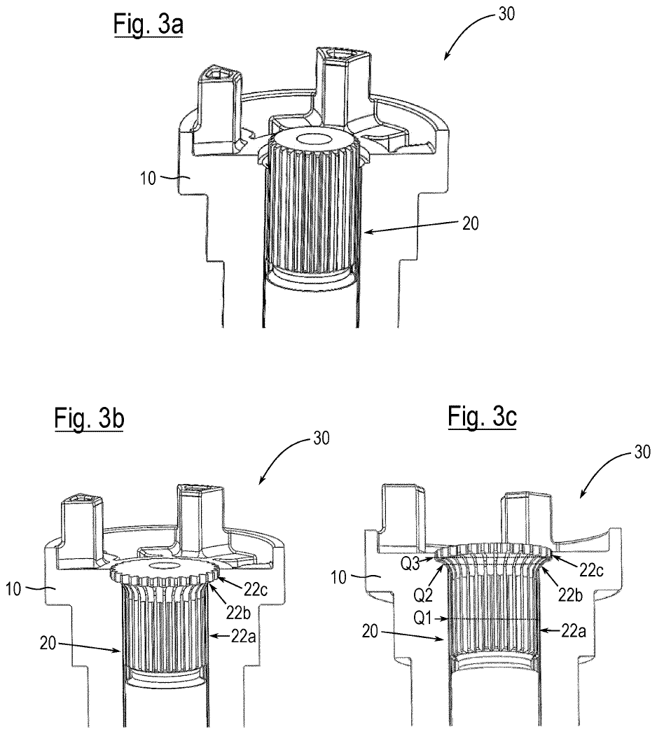

FIGS. 3a to 3c show the shaft-hub assembly during connection and after connection of shaft and hub in two views.

In FIGS. 1a and 1b, a hub of a shaft-hub assembly according to the invention is initially designated by the reference sign 10 and shown in two states, namely before connection to a corresponding shaft and afterwards, wherein in the representation in FIG. 1b, a representation of the shaft has been initially omitted for reasons of clarity.

Here, in the embodiment shown, the hub 10 can, for example, represent a clutch housing of a spindle drive. Here, the hub 10 can in particular be produced from a relatively soft metal material or a plastics material and comprises an opening 12 extending in the axial direction A, which extends through the entire body 10a of the hub 10. Furthermore, it can be seen in FIG. 1a that the opening 12 comprises a first axial portion 12a having a substantially constant cross section Q1, wherein the wall of the openings in the first axial portion 12a has a toothed or corrugated profile 14.

Adjoining this in the axial direction, the opening 12 further comprises a second axial portion 12b, which expands, proceeding from the first axial portion 12a, from a first cross section Q1 that corresponds to the cross section Q1 of the first axial portion 12a, to a second, larger cross section Q2. Adjoining this is a third axial portion 12c having a substantially constant cross section Q3, which is in turn larger than the second cross section Q2, so that a step 12d is formed between the second axial portion 12b and the third axial portion 12c. It can be seen that the second and third portions 12b and 12c along with the step 12d are each free of the toothed or corrugated profile 14 that is found in the first portion 12a.

With reference to FIG. 1b, it can now be seen that after connection to the hub 10 to the shaft shown in the following figures, by pressing a corresponding portion of the shaft into the material of the hub 10, a corresponding toothed or corrugated profile 14 has also been formed in the second and third portions 12b and 12c along with the step 12d, as a result of which a frictional and form-locking connection has been established between the two components.

In FIG. 2a to 2c, the corresponding shaft 20 of the shaft-hub assembly according to the invention is shown and generally designated by the reference sign 20. In the state from FIG. 2a, not yet connected to the hub 10 from FIGS. 1a and 1b, the shaft 20 is still cylindrical in the axially upper region thereof having a substantially constant cross section Q1, wherein it only has, on the outside thereof, a toothed or corrugated profile 24 complementary to the opening of the hub 10. Furthermore, an axial stop 26 is provided in the axially lower region of the shaft 20, which axial stop limits the insertion of the shaft 20 into the opening 12 of the hub 10 in this direction. On the axial upper side thereof, the shaft 20 further has a blind hole 28 in a radially central part.

In FIGS. 2b and 2c, the shaft 20 is now shown in a state in which it is connected to the hub 10 from FIGS. 1a and 1b, wherein, however, a representation of the hub 10 has initially been omitted for reasons of visibility. Here, it can be seen that after a corresponding deformation, the shaft 20 now comprises a first axial portion 22a, in which the shaft 20 has the first constant cross section Q1 that corresponds to the cross section Q1 of the opening 12 of the hub 10 in the first portion 12a thereof. Adjoining this in the axial direction is a second axial portion 22b, which expands in the axial direction proceeding from the first cross section Q1 to a second, larger cross section Q2, while a third axial portion 22c further adjoins this second axial portion 22b and has a substantially constant third cross section Q3, which is larger than the second cross section Q2.

Finally, in FIG. 3a to 3c, the shaft-hub assembly 30 is shown in a state in which the shaft 20 has already been inserted into the opening 12 of the hub 10, but has not yet been deformed. As already mentioned, in this state the stop 26, not shown in FIG. 3a, can limit the insertion of the shaft 20 into the opening 12 of the hub 10 in the axial direction A.

Furthermore, in FIGS. 3b and 3c, the shaft-hub assembly 30 is shown in two views in the ultimately connected state thereof, wherein it can be seen that a form-locking and frictional connection has been achieved between the hub 10 and the shaft 20 through the interaction of the individual axial portions of the two components and in particular the pressing of the third axial portion 22c of the shaft 20 into the material of the hub 10 in the region of its third portion 12c along with the axial contact on the step 12d.

1. A shaft-hub assembly comprising:
a hub which is provided with an axially extending opening, and
a shaft which is inserted into the opening of the hub,
wherein the shaft comprises at least the following portions:
a first axial portion, in which the shaft substantially has a constant cross section (Q1); and
a second axial portion which expands, proceeding from the first axial portion, substantially from a first cross section (Q1) that corresponds to the cross section (Q1) of the first axial portion to a second, larger cross section (Q2);
characterized in that the shaft further comprises a third axial portion, which adjoins the second axial portion and which has a substantially constant third cross section (Q3), which is the same as or larger than the second cross section (Q2), and which establishes a form-locking and frictional connection with the hub, and
wherein the third axial portion forms an axial end portion of the shaft and the first to third axial portions have, in the outside thereof, respective toothed or corrugated profiles.

2. The shaft-hub assembly according to claim 1,
wherein the third axial portion of the shaft is pressed into the material of the hub.

3. The shaft-hub assembly according to claim 1, wherein the shaft is formed from a harder material than the hub.

4. The shaft-hub assembly according to claim 3, wherein the shaft is formed from a metal material and the hub is formed from a softer metal material or a plastics material.

5. The shaft-hub assembly according to claim 1, wherein a radial step is provided between the second axial portion and the third axial portion of the shaft.

6. The shaft-hub assembly according to claim 1, wherein the second axial portion expands substantially conically proceeding from the first axial portion to the third axial portion.

7. The shaft-hub assembly according to claim 1, wherein the shaft is provided with a blind hole in a radially central part of the third axial portion.

8. The shaft-hub assembly according to claim 1, wherein the shaft has an axial stop and is inserted into the hub up to this stop.

9. A method for producing a shaft-hub assembly, comprising the following steps:
providing a hub which is provided with an axially extending opening wherein the opening comprises:
a first axial portion having a substantially constant cross section (Q1),
a second axial portion which expands, proceeding from the first axial portion substantially from a first cross section (Q1) that corresponds to the cross section (Q1) of the first axial portion to a second, larger cross section (Q2); and
a third axial portion having a substantially constant cross section (Q3);
providing a shaft having a substantially constant first cross section (Q1) that corresponds to the cross section (Q1) of the first axial portion of the opening wherein the shaft has, on the outside thereof, a toothed or corrugated profile and the opening of the hub has a complementary profile at least in the first axial portion thereof; and
deforming the shaft such that a second portion that corresponds to the second axial portion of the opening and a third portion are formed, wherein the third portion of the shaft has a larger cross section (Q3) than the third axial cross section (Q3) of the hub by pressing the third axial portion of the shaft into the material of the hub.

10. The method according to claim 9,
wherein only the first axial portion of the opening of the hub has the complementary profile upon provision thereof, while the second axial portion and the third axial portion are free of such a profile.

11. The method according to claim 10,
wherein the step of deformation is carried out by an application of axial punching or pressing.
